(19) United States
(12) Patent Application Publication
(10) Pub. No.: US 2005/0128039 A1
(43) Pub. Date: Jun. 16, 2005

(54) Structure of coil inductor wave filter magnet core

(76) Inventor: Kung-Hua Weng, Lu Chu Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/735,784

(22) Filed: Dec. 16, 2003

(51) Int. Cl. H01F 27/29

(52) U.S. Cl. 336/192

(57) ABSTRACT

An improved structure of coil inductor wave filter magnet core comprised of double standoffs having a separator disposed at the center rod area that is smaller in diameter than the double standoffs and a minimum of one aligned locating notch at the bottom section of the double standoffs. As such, the spaces between the double standoffs and the separator respectively provide for winding copper wire to construct an inductive wave filter with a lower overall wave filter coil stray capacitance to achieve higher wave efficiency. The aligned locating notches disposed at the bottom section of the double standoffs are respectively shunted to the two terminals of a reel switch, and the magnetic induction of the wave filter is such that current flowing from the wave filter controls the opening and closing of the reel switch. When utilized with a splitter, the ADSL and telephone signal used at the same time are individually differentiated via the reel switch and transferred along its path such that the signal is not subjected to interference, ensuring optimal telephone communications quality.

### BACKGROUND OF THE INVENTION

1) Field of the Invention

The invention herein relates to electronic components, specifically an improved structure of coil inductor wave filter magnet core.

2) Description of the Prior Art

A conventional coil inductor-use magnet core structure is typically, as shown in FIG. 1, comprised of a small diameter center rod 11 positioned at large diameter double standoffs 10 and connected between the double standoffs 10, wherein the said center rod 11 provides for winding copper wire 2 and the double standoffs 10 have two pins 3 connected to the copper wire 2 to form an inductor, and the two pins 3 of the said inductor are inserted into holes and soldered to the circuit board (not shown in the drawings), the said inductor capable of providing for an expected utilization function in the circuit board circuit.

The said double standoffs 10 and the center rod 11 form an H-shaped magnetic core 1 and after configuration with copper wire 2 and pins to form a coil inductor component, it is usually configured with other circuit components on the circuit board to directly provide a single function for a certain application (such as operation as a coil inductor wave filter).

Although the said magnetic core arrangement, in terms of inductors, is definitely capable of achieving expected utilization objectives and results, and are in widespread use by manufacturers, for different electronic product requirements, the applicant of the invention herein became aware that such magnetic core structures still have aspects needing improvement that would enable more multi-faceted applicability.

When the said inductors consisting of the H-shaped magnetic core, copper wire, and pins are utilized today with Asymmetric Digital Subscriber Line (ADSL) splitters, since the said splitters use circuit board circuits, components, and inductors of a set configuration, and the ADSL and telephone signal proceed through the same circuit, the main utilization of the said inductor is the handling of waves; however, since it is known that ADSL and telephone signals share the same path inside the splitter and that the said different frequency ADSL and telephone signals do not generate interference during individual network operation and telephone communication, but during simultaneously conducted network and voice call operation, the said different frequency signals mixing on the same path cannot but generate interference noise, and although such noise can be reduced by an inductor, total elimination is not possible, the said noise causing unclear voice call quality and uncomfortable listening which is an even more immediately obvious drawback and, furthermore, the most serious shortcoming to most users.

Based on the above elaboration, although the said conventional inductor and ADSL splitter utilization arrangement is capable of slight noise reduction in simultaneous network and voice call operation, the reception of different frequency signals has transmission limits because they must mix on the same path, the generated noise of which cannot be entirely eliminated, which at present is the most serious inadequacy of splitters and, of course, such shortcomings await and, furthermore, require improvement.

### SUMMARY OF THE INVENTION

The primary objective of the invention herein is to provide an improved structure of coil inductor wave filter magnet core in which the said magnetic core has a separator disposed at the center diameter area that is smaller than the double standoffs such that after copper wire is respectively wound between the separator and the double standoffs to construct an inductive wave filter, not only is the total wave filter coil stray capacitance lower to increase wave efficiency, but a minimum of one aligned locating notch is disposed at the bottom section of the double standoffs and, furthermore, after the said aligned locating notches are respectively shunted on the two terminals of a reel switch, the inductive wave filter magnetic induction and flowing current directly control the switching on and off of the reel switch, and when utilized with a splitter, through the circuit components, the ADSL and telephone signal used at the same time are individually differentiated via the reel switch and transferred along its path to the telephone, and not transferred with the ADSL on the said path such that the voice call signal is not subjected to interference from the ADSL signal, ensuring optimal telephone communications quality.

### BRIEF DESCRIPTION OF THE DRAWINGS

FIG. 1 is an isometric drawing of a conventional coil inductor-use magnet.

FIG. 2 is an isometric drawing of the invention herein.

FIG. 3 is an isometric drawing of FIG. 2, as viewed from another perspective.

FIG. 4 is an orthographic drawing of the invention herein, the double standoffs shunted across the two terminals of the reel switch.

FIG. 5 is an orthographic drawing of FIG. 4, as viewed from a lateral perspective.

FIG. 6 is a schematic diagram of the invention herein utilized in an ADSL splitter embodiment (1).

FIG. 7 is a schematic diagram of the invention herein utilized in an ADSL splitter embodiment (2).

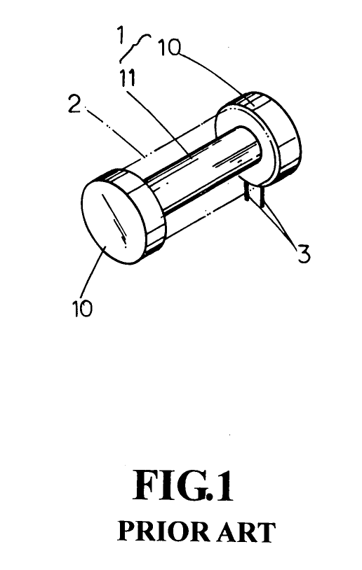

### DETAILED DESCRIPTION OF THE INVENTION

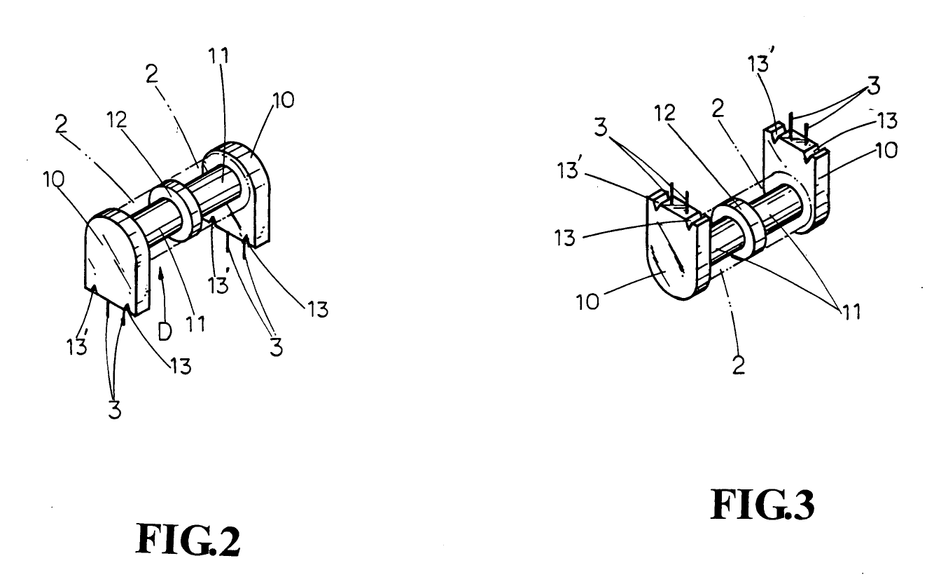

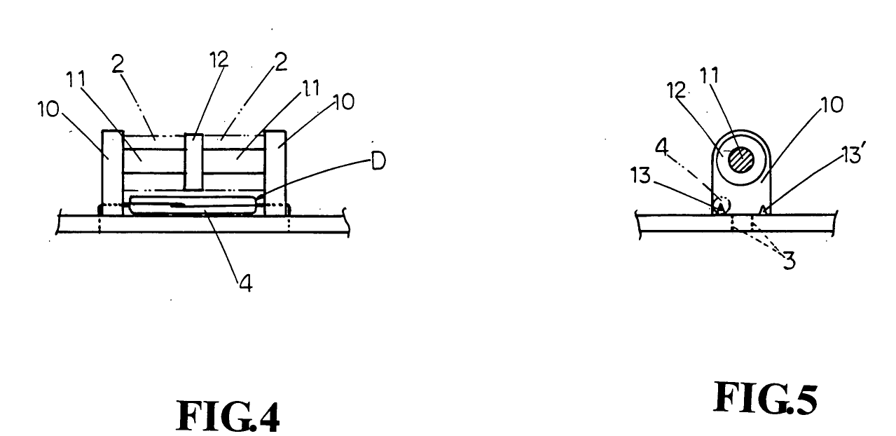

Referring to FIG. 2 and FIG. 3, the Improved structure of coil inductor wave filter magnet core of the invention herein is comprised of a separator 12 disposed at a double standoffs 10 center rod 11 area that is smaller in diameter than the double standoffs 10, and two pins 3 as well as a minimum of one aligned locating notch 13 (13′) at the bottom section of the double standoffs 10. Referring to FIG. 4 and FIG. 5, copper wire 2 windings are respectively wrapped around the center rod 11 between the said double standoffs 10 and the separator 12 which are respectively routed to pins 3 disposed at the bottom section of the double standoffs 12, thereby forming an inductive wave filter, wherein the overall wave filter coil stray capacitance is much lower such that wave efficiency is even higher; additionally, utilizing the said separator 12 that is smaller than the double standoffs 10 results in the forming of an accommodating space D between the lower ends of the double standoffs 10, and the said aligned locating notches 13 (13′) disposed at the double standoffs 10 are respectively shunted to the two terminals of a reel switch 4, the reel switch 4 ensconced in the accommodating space D between the double standoffs 10, while the magnetic inductance of the wave filter is such that current flowing from the wave filter directly controls the opening and closing of the reel switch 4.

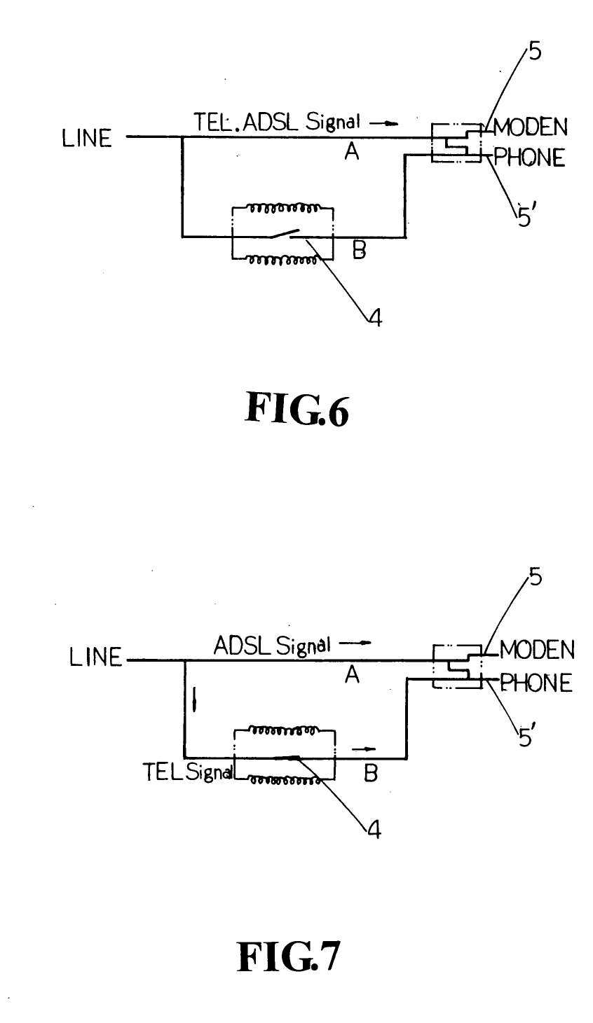

Referring to FIG. 6 and FIG. 7, the said arrangement of the invention herein, when utilized with an ADSL splitter (for single-line telephones), if either network or telephone voice operation alone occurs via the circuit board circuit and components (shown in FIG. 6), then the reel switch 4 shunted to the said two terminals is controlled into a switched on, closed circuit state by the magnetic cored double standoffs 10, and the said ADSL signal and telephone signal is directly transferred from path A to a computer modem connector 5 or a telephone connector 5′; conversely, when the network operation and telephone communication occurs (as shown in FIG. 7), then the said reel switch 4 is automatically controlled into a switched off continuity state, such that the telephone signal is automatically transferred via the circuit components along the reel switch 4 path B to the telephone connector 5′, and the said ADSL signal at the same continues being transferred along path A to the computer modem connector 5; as such, since the said telephone signal is individually differentiated and not mixed with the ADSL signal and transferred on the same path, the noise and interference generated by the prior art wherein two signals are mixed and transferred along the same path is definitely and, furthermore, effectively eliminated and, furthermore, telephone communications quality is optimal because voice call quality is even clearer and listening is much more comfortable.

In other words, since the utilization of the magnetic core simplification improvement of the invention herein via the circuit board circuit and components integrates the inductive wave filter and the switch into a single entity such that simultaneous network and voice call operation occurs at a telephone communications quality having higher efficiency when utilized with the ADSL splitter, then in terms of the present invention, the invention herein not only provides for simplified, convenient, and economical production, but affords ADSL splitter usage that exceeds actual requirements for even better performance.

Of course, if the magnetic core coil inductor wave filter of the invention herein is not connected to a shunted reel switch, the circuit board circuit components alone are still capable of reduced coil stray capacitance to thereby enable wave filter efficiency for enhanced multifaceted applicability.

1. An improved structure of coil inductor wave filter magnet core, the features of which include a separator disposed on a double standoff center rod that is smaller than the said double standoffs, an accommodating space formed between the lower ends of the said double standoffs, a minimum of one aligned locating notch disposed at the bottom section of the said double standoffs, and the said aligned locating notches disposed in the said double standoffs are respectively shunted to the two terminals of a reel switch.
